(19) United States
(12) Patent Application Publication
(10) Pub. No.: US 2021/0241222 A1
(43) Pub. Date: Aug. 5, 2021

(54) INTERACTIVE MOVING SERVICES SYSTEM AND METHOD

(71) Applicant: YEMBO, INC., San Diego, CA (US)

(72) Inventors: Zachary RATTNER, San Diego, CA (US); Siddharth MOHAN, San Diego, CA (US)

(21) Appl. No.: 17/162,478

(22) Filed: Jan. 29, 2021

Related U.S. Application Data
(60) Provisional application No. 62/969,591, filed on Feb. 3, 2020.
(60) Provisional application No. 62/968,563, filed on Jan. 31, 2020.

(51) Int. Cl. G06Q 10/08; G06K 19/077; G06T 7/00; G06Q 50/30

(52) U.S. Cl. CPC G06Q 10/0832; G06Q 10/0833; G06Q 50/30; G06T 7/001; G06K 19/0776

(57) ABSTRACT

An interactive moving services system and method are described. An itemized statement of moving work to be performed by a moving services provider is received. The itemized statement of moving work comprises individual elements a user intends to move and services needed for moving the elements. A list of required actions for the moving services provider is determined. The required actions are determined based on the itemized statement of moving work. Identification tags for the individual elements are generated. The identification tags comprise an image of a given individual element and/or a unique identification code for the given individual element. The list of required actions and the identification tags are provided to the moving services provider.

### RELATED APPLICATIONS

This present application claims priority to and the benefit of U.S. provisional patent applications 62/968,563, filed Jan. 31, 2020 and 62/969,591, filed Feb. 3, 2020, the disclosures of each are hereby incorporated by reference in their entirety.

### FIELD OF THE DISCLOSURE

This disclosure relates to systems and methods for providing interactive moving services.

### BACKGROUND

Conventional systems and methods for providing cost estimates for moving services are lacking. The way estimates are done today are either inaccurate (phone calls/web forms) or very expensive to administer (in-person estimates). There are also some estimating solutions that are essentially video calls (one may think of them like a skinned Facetime or Skype app), but these solutions still require synchronous estimator interactions to administer and thus may be expensive and inconvenient to the consumer. These systems also do not actively manage and/or otherwise facilitate individual aspects of an actual move. For example, these systems are not configured to manage inventory, mark items as packed, loaded, unloaded, etc., or annotate damage.

### SUMMARY

One aspect of the disclosure relates to an interactive moving services system. The system comprises one or more hardware processors configured by machine readable instructions. The one or more hardware processors are configured to receive an itemized statement of moving work to be performed by a moving services provider. The itemized statement of moving work comprises individual elements a user intends to move and services needed for moving the elements. The one or more hardware processors are configured to determine a list of required actions for the moving services provider. The required actions are determined based on the itemized statement of moving work. The one or more hardware processors are configured to generate identification tags for the individual elements (e.g., a tag may be generated for a television). In some implementations, the one or more hardware processors are configured to generate a single identification tag for a group of elements (e.g., one tag may be generated for all elements such as packing material, furniture, etc., in a room). The identification tags comprise an image and/or other representation of a given individual element and/or a unique identification code for the given individual element. The one or more hardware processors are configured to provide the list of required actions and/or the identification tags to the moving services provider.

Another aspect of the disclosure relates to an interactive moving services method. The method is performed by one or more hardware processors configured by machine readable instructions. The method comprises receiving an itemized statement of moving work to be performed by a moving services provider. The itemized statement of moving work comprises individual elements a user intends to move and services needed for moving the elements. The method comprises determining a list of required actions for the moving services provider. The required actions are determined based on the itemized statement of moving work. The method comprises generating identification tags for the individual elements (e.g., a tag may be generated for a television). In some implementations, a single identification tag may be generated for a group of elements (e.g., one tag may be generated for all elements such as packing material, furniture, etc., in a room). The identification tags comprise an image and/or other representation of a given individual element and/or a unique identification code for the given individual element. The method comprises providing the list of required actions and/or the identification tags to the moving services provider.

Yet another aspect of the disclosure relates to a non-transitory computer readable medium having instructions thereon. The instructions, when executed by a computer, cause the computer to: receive an itemized statement of moving work to be performed by a moving services provider, the itemized statement of moving work comprising individual elements a user intends to move and services needed for moving the elements; determine a list of required actions for the moving services provider, the required actions determined based on the itemized statement of moving work; generate identification tags for the individual elements (e.g., a tag may be generated for a television and/or a single identification tag may be generated for a group of elements—e.g. one tag may be generated for all elements such as packing material, furniture, etc., in a room), the identification tags comprising an image and/or other representation of a given individual element and/or a unique identification code for the given individual element; and provide the list of required actions and/or the identification tags to the moving services provider.

In some implementations, a determination of whether auxiliary moving components and/or services are required for the individual elements is made. The list of required actions, the auxiliary moving components and/or services, and the identification tags may be provided to the moving services provider.

In some implementations, the individual elements comprise furniture, appliances, dishes, utensils, wall hangings, art, rugs, and/or light fixtures.

In some implementations, the required actions comprise packing specific individual elements, loading specific individual elements, moving specific individual elements from a first location to a second location, unloading specific individual elements, unpacking specific individual elements, installing and/or removing a protective component configured to protect one or more features of a building during a move, and/or obtaining moving assistance equipment configured to ease movement of one or more of the individual elements.

In some implementations, the identification tags are electronic and configured to be printed and physically attached to corresponding individual elements.

In some implementations, a printed unique identification code is configured to be scanned by a computing device associated with the user and/or the moving services provider to automatically identify a corresponding individual element (and an associated user record) responsive to the scan.

In some implementations, the identification tags are configured to be printed before a move with a laser and/or inkjet printer, with a mobile and/or Bluetooth printer, and/or a thermal printer.

In some implementations, adjustments to the list of required actions and/or the identification tags by the moving services provider and/or a user are received. The adjustments are entered and/or selected by the moving services provider via a user interface associated with the moving services provider and/or by the user via a user interface associated with the user.

In some implementations, the adjustments comprise adding or removing actions from the list of required actions, adding or removing auxiliary moving components, adding or removing identification tags, adding or removing images associated with the identification tags, and/or changing images associated with the identification tags.

In some implementations, entry and/or selection of additional information, images, and/or video associated with one or more of the individual elements may be received from the moving services provider.

In some implementations, the additional information comprises a status of individual elements.

In some implementations, the status of individual elements comprises one or more of damaged, packed, loaded, or unloaded.

(18) In some implementations, interactions by the moving services provider and/or a user may be timestamped, geostamped, and/or user stamped.

In some implementations, interactions comprise one or more of requesting authorization to adjust a price based on a change in services; confirming a quality of one or more of the individual elements, a building, vehicles, and/or surrounding area; taking payment; identifying separate shipments for a move and/or confirming what is in a shipment and where the shipment is going; adding, removing, and/or confirming packing material and/or services; or adding, removing, and/or confirming storage services.

In some implementations, the list of required actions is arranged by user, and/or by areas within a premises associated with a given user.

In some implementations, the premises comprises a building, and the areas within the premises comprise rooms.

In some implementations, the auxiliary moving components and/or services comprise protective packaging, disassembly, and/or reassembly.

In some implementations, printing of one or more documents associated with the list of required actions and the identification tags is facilitated.

In some implementations, a determination of whether one or more items on the list of required actions was not completed is made, and a warning is generated responsive to one or more of the items on the list of required actions not being completed.

In some implementations, the list of required actions is synced from a pre-move inventory that was completed by a user, the moving services provider, and/or a third party.

In some implementations, a determination may be made of a non-moving element from items identified from the images; and an annotation may be added to the non-moving element utilizing a graphical user interface.

In another aspect of the present disclosure, an interactive moving services system includes one or more hardware processors configured by machine readable instructions to: receive, at an Al module, an image of an object acquired by an image capture device; compare, by the Al module, at least a portion of the image corresponding to the object to images in a training library; determine, by the Al module, based on the comparing, whether the portion of the image indicates that the object is damaged; and generate an indication of the determined damage.

In some implementations, the one or more hardware processors are further configured to: receive one or more bounding boxes surrounding the portion of the image, wherein the determining is further based on the portion of the image inside the one or more bounding boxes.

In some implementations, the one or more hardware processors are further configured to: compare the portion of the image to images of known damage types present in the training library; and determine a type of damage present with the object based on the comparing with the known damage types.

### BRIEF DESCRIPTION OF THE DRAWINGS

FIG. 1 illustrates an interactive moving system, in accordance with one or more implementations.

FIG. 2 illustrates an artificial intelligence (Al) framework which includes a model that may be trained to perform one or more operations described herein, in accordance with one or more implementations.

FIG. 3 illustrates an exemplary system wherein a deployment server running an Al framework may include a consumer interaction module, a service provider interaction module, a driver/crew interaction module, a database, and an Al improvement engine. The Al improvement engine may run on one or more of machine learning algorithms, Al algorithms, and/or other algorithms, in accordance with one or more implementations.

FIG. 4 illustrates an iterative way data is collected and analyzed, in accordance with one or more implementations.

FIG. 5 illustrates another iterative way data is collected and analyzed, in accordance with one or more implementations.

FIG. 6 illustrates a driver/crew interacting with a driver/crew interaction module that is part of the system, in accordance with one or more implementations.

FIG. 7 illustrates an example work flow comprising example operations performed by various processor components shown in FIG. 1, in accordance with one or more implementations.

FIG. 8 illustrates a checklist of elements that need to be packed, loaded, or unloaded, in accordance with one or more implementations.

FIG. 9 illustrates marking individual elements as packed, loaded, or unloaded, in accordance with one or more implementations.

FIG. 10 illustrates timestamping, geostamping, and user stamping interactions, in accordance with one or more implementations.

FIG. 11 illustrates marking an element as damaged, and adding extra images, in accordance with one or more implementations.

FIG. 12 illustrates three different examples of possible identification tags, in accordance with one or more implementations.

FIG. 13 illustrates automatic recognition of a code on an identification tag, in accordance with one or more implementations.

FIG. 14 illustrates a view of a graphical user interface showing list of automatically generated additional documents associated with a move, in accordance with one or more implementations.

FIG. 15 illustrate a method for providing interactive moving services, in accordance with one or more implementations.

FIG. 16 illustrates an Al module being trained to determine whether an object is damaged based on available images, in accordance with one or more implementations.

FIG. 17 illustrates an Al module accepting an object identification tag and/or a damage identification tag, in accordance with one or more implementations.

FIG. 18 illustrates an Al module making a prediction based on an available image, in accordance with one or more implementations.

FIG. 19 illustrates an algorithm, which may be implemented in a system or as a computer-implemented method, for an Al module determining whether an object is damaged based on available images.

### DETAILED DESCRIPTION

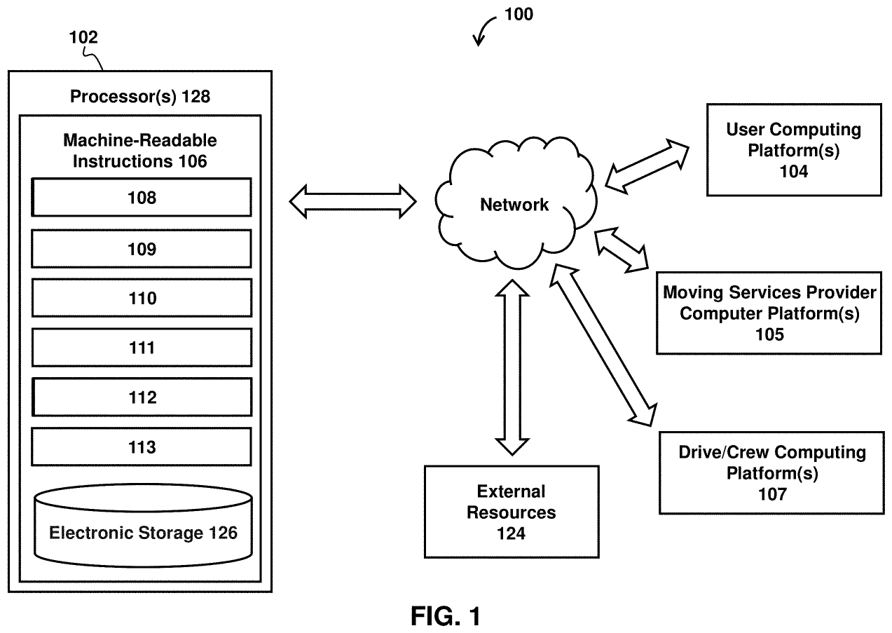

FIG. 1 illustrates an interactive moving system 100 configured to provide a novel way of providing moving services using a deep learning/natural language processing (e.g., artificial intelligence (Al)) powered system and/or other machine learning models. The present technology may make moving into a more interactive experience. Consumers and moving services providers may interactively engage system 100 and/or each other to enhance the moving experience for the customer and/or the moving services provider. In some implementations, system 100 may be configured to autogenerate a list of actions for a moving services provider, provide individualized tracking tags for moved items or a group of items, userstamp (e.g., identify the user(s) that performed certain actions), timestamp, and/or geostamp interactions with the system by the customer and/or the moving services provider, and/or provide other advantageous features. Such a system ensures that inventory items are synced automatically from a pre-move survey completed by a user, moving service provider, and/or a third party, automatically with the relevant images of the inventory. This enables enhanced collaboration between the user, the moving service provider, third parties, as well as driver and crew (if separate from the moving services provider) to facilitate execution of a move. This collaboration and added transparency allows moving services providers to eliminate expensive mistakes (for e.g. send the wrong size truck to users' home), provides an audit trail to identify sources of errors (for e.g. specific crew members being not careful with packing specific items), and rectifying them for future moves, as well as providing a visual representation of how the move is executed to various parties involved.

In some implementations, system 100 may include one or more server(s) 102, user computing platform(s) 104, moving services provider computing platform(s) 105, driver/crew computing platform(s) 107, external resources 124, and/or other components. As shown in FIG. 1, server 102 may include electronic storage 126, one or more processors 128, and/or other components.

As described herein a moving services provider may be a moving company, a moving equipment provider, individual movers (e.g., individual people who may be hired to physically move the individual elements such as furniture, appliances, etc.), a representative of one or more of these entities, and/or other moving services providers (for example a third party performing crating services or assembly/disassembly services). A user may be a person, a family, a business, and/or others who want items moved from one premises to another. A driver/crew member may be a person responsible for driving a moving truck and/or physically moving elements from one premises to another. The driver/crew may be and/or be part of the moving services provider. By way of nonlimiting example, the moving services provider may be a moving company hired to move the belongings of a user from an old house the user has sold and or otherwise vacated, to a new house the user intends to occupy. The driver/crew may be and/or be hired by the moving services provider to physically move the various elements. This example may be extended to the offices of a business, for example, and/or may have other extensions.

Server(s) 102 may be configured to communicate with one or more user computing platforms 104, moving services provider computing platforms 105, driver/crew computing platforms 107, and/or other computing devices according to a client/server architecture and/or other architectures. In some implementations, server 102 may include an application program interface (API) server, a web server, a cache server, and/or other components. These components may be formed by one or more processors 128 and/or other components. These components, in some implementations, communicate with one another in order to provide the functionality of server 102 described herein. The cache server may expedite access to data stored by server 102 by storing likely relevant data in relatively high-speed memory, for example, in random-access memory or a solid-state drive. The web server may serve webpages having graphical user interfaces that display moving application views (e.g., as described below) and/or other displays. The API server may serve data to various versions of the moving application (e.g., run by user computing platforms 104, moving services provider computing platform 105, driver/crew computing platforms 107, and/or other computing platforms). The operation of these server components may be coordinated by a controller which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, components, modules, or objects within an application or process, e.g., by reference or by value. In some implementations, server 102 may be and/or include one or more cloud based servers.

Electronic storage 126 may comprise electronic storage media that electronically stores information (e.g., an itemized statement of work and/or other moving information as described herein). The electronic storage media of electronic storage 126 may comprise one or both of system storage that is provided integrally (i.e., substantially non-removable) with system 100 and/or removable storage that is removably connectable to system 100 via, for example, a port (e.g., a USB port, a firewire port, etc.) or a drive (e.g., a disk drive, etc.). Electronic storage 126 may be (in whole or in part) a separate component within system 100, or electronic storage 126 may be provided (in whole or in part) integrally with one or more other components of system 100 (e.g., external resources 124, a computing platform 104, 105, 107, processor 128, etc.). In some implementations, electronic storage 126 may be located in server 102 together with processor 128, in a server that is part of external resources 124, and/or in other locations. Electronic storage 126 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 128 may store software algorithms, machine readable instructions 106, information determined by processor 128, information received by system 100 via computing platforms 104, 105, 107, and/or other computing systems, information received from external resources 124, and/or other information that enables system 100 to function as described herein.

Processor 128 may be configured to provide information processing capabilities in system 100. As such, processor 128 may comprise one or more of a digital processor, an analog processor, a digital circuit designed to process information, an analog circuit designed to process information, a state machine, and/or other mechanisms for electronically processing information. Although processor 128 is shown in FIG. 1 as a single entity, this is for illustrative purposes only. In some implementations, processor 128 may comprise a plurality of processing units. These processing units may be physically located within the same device (e.g., server 102), or processor 128 may represent processing functionality of a plurality of devices operating in coordination (e.g., one or more servers, devices that are part of external resources 124, computing platforms 104, 105, 107, electronic storage 126, and/or other devices.)

In some implementations, processor 128, external resources 124, computing platforms 104, 105, 107, and/or other components may be operatively linked via one or more electronic communication links. For example, such electronic communication links may be established, at least in part, via a network such as the Internet, and/or other networks. It will be appreciated that this is not intended to be limiting, and that the scope of this disclosure includes implementations in which these components may be operatively linked via some other communication media. In some implementations, processor 128 may be configured to communicate with these and/or other components according to a client/server architecture, a peer-to-peer architecture, and/or other architectures.

As shown in FIG. 1, processor 128 may be configured via machine-readable instructions 106 to execute one or more computer program components. The one or more computer program components comprise one or more of an information component 108, an actions component 109, an adjustment component 110, a tag component 111, a communication component 112, an interaction component 113, and/or other components. Processor 128 may be configured to execute the components by software; hardware; firmware; some combination of software, hardware, and/or firmware; and/or other mechanisms for configuring processing capabilities on processor 128.

It should be appreciated that although the components are illustrated in FIG. 1 as being co-located within a single processing unit, in implementations in which processor 128 comprises multiple processing units, one or more of the components may be located remotely from the other components. The description of the functionality provided by the different components described below is for illustrative purposes, and is not intended to be limiting, as any of the components may provide more or less functionality than is described. For example, one or more of the components may be eliminated, and some or all of its functionality may be provided by other components. As another example, processor 128 may be configured to execute one or more additional components that may perform some or all of the functionality attributed below to one of components 108, 109, 110, 111, 112, and/or 113.

Information component 108 may be configured to receive an itemized statement of moving work to be performed by a moving services provider. The itemized statement of moving work may comprise individual elements a user intends to move, services needed for moving the elements, moving costs, moving dates and/or times, and/or other information. In some implementations, the individual elements may comprise furniture, appliances, dishes, utensils, wall hangings, art, rugs, light fixtures, and/or other elements. The services may include assembly, disassembly, removal, installation, and/or other actions associated with one or more of the individual elements, and/or other services.

The itemized statement of moving work to be before performed by a moving services provider may include a list of elements, pictures of the elements, services required for each element, moving cost and/or costs associated with individual elements, address information (e.g., information show where elements are being moved from and/or where the elements are being moved to), timing information (e.g., a move date and/or other dates), and or other information. In some implementations, the itemized statement of moving work may be similar to and/or the same as the itemized statement and quote of work to be performed described in U.S. patent application Ser. No. 15/494,423 (filed Apr. 21, 2017 and entitled “Algorithm for Generating an Itemized Statement of Work and Quote for Home Services Based on Two Dimensional Images, Text, and Audio”) and/or the interactive quotes describe in U.S. patent application Ser. No. 16/374,449 (filed Apr. 3, 2019 and entitled “Systems and Methods for Providing Al-Based Cost Estimates for Services”). Both of these applications are incorporated herein by reference. As an example, the itemized statement of moving work to be performed by a moving services provider may be generated as described in either and/or both of these references, and/or may include information similar to and/or the same as the itemized statements and quotes of work, and/or the interactive quotes, described in these references.

Actions component 109 may be configured to determine a list of required actions. The list of required actions may include actions necessary to move one or more items from one premises associated with a user to another premises associated with the user. In some implementations, the premises may comprise a building such as a house, and the areas within the premises comprise rooms, for example. As another example, the premises may comprise the offices of a business. These examples are not intended to be limiting.

The list of required actions may be determined for the moving services provider, the driver/crew, and/or others. Stated another way, the list of required actions may be determined knowing that the list of required actions will eventually be transmitted to a moving services provider, who may then transmit the list of required actions to a driver/crew. The required actions may be determined based on the itemized statement of moving work, and/or other information. For example, for individual elements, actions component 109 may determine individual required actions for the disassembly, packing, moving, unpacking, reassembly, and/or other actions for a given element. The required actions may comprise packing specific individual elements, loading specific individual elements, moving specific individual elements from a first location to a second location, unloading specific individual elements, unpacking specific individual elements, installing and/or removing a protective component configured to protect one or more features of a building during a move, obtaining moving assistance equipment configured to ease movement of one or more of the individual elements, and/or other required actions.

In some implementations, the list of required actions may be arranged, by actions component 109, a user, a moving services provider, and/or a driver/crew, by areas within a premises associated with a given user, and/or by other factors. For example, a moving services provider may have two or more different customers (where different users are different customers). A different list of required actions may be determined for each different user, for example, because each different user is associated with a different premises where elements need to be moved to or from. As another example, individual elements associated with a single user and/or a single premises may be arranged by different rooms of the premises. This may enable the moving services provider and/or a driver/crew to complete required actions room by room, for example, and/or have other advantages. These examples are not intended to be limiting.

In some implementations, the list of required actions may be synced from a pre-move inventory that was completed by a user, the moving services provider, and/or a third party. Synching may include electronically accessing information on a computer computing platform associated with the user, a moving services provider, and or others. Electronically accessing may include uploading, downloading, and/or otherwise electronically obtaining information.

For example, a user may use the user's smartphone to record images of elements in the user's house, record an audio list of these elements, enter and/or select these elements via a user interface, and/or make an inventory of their belongings by some other method. The user may also list actions they think are required to move the belongings. This information may be stored in the cloud, in a database associated with server 102, on the user's smartphone, and/or in other locations. Actions component 109 may be configured to electronically access these and/or other storage locations to complete the synching. Similar examples are contemplated with respect to the moving services provider.

Adjustment component 110 may be configured to adjust the list of required actions. Adjustments may be received from the moving services provider and/or a user. For example, one or more hardware processors 128 may be configured such that the adjustments are entered and/or selected by the moving services provider via a user interface associated with the moving services provider (e.g., presented via a moving services provider computing platform 105) and/or by the user via a user interface associated with the user (e.g., presented via a user computing platform 104), for example. In some implementations, an adjustment may include adding and/or removing required actions, for example, and/or other adjustments. In some implementations, adjusting may include receiving entry and/or selection of additional information, images, and/or video associated with one or more of the individual elements from the moving services provider, for example, the user, and/or others.

In some implementations, the additional information may comprise a status of individual elements, and/or other information. The status of individual elements may comprise one or more of damaged, packed, loaded, unloaded, and/or other statuses. For example, a moving services provider (e.g., a driver/crew) may arrive at a premises to move the individual elements and discover that one element is damaged. The moving services provider may provide additional information to document the damage. The additional information may include pictures, video, text, and audio recording, and/or other information. The additional information may be provided via a moving services provider computing platform 105, for example.

In some implementations, adjusting the list of required actions may include determining whether auxiliary moving components and/or services are required for induvial elements in the list of required actions. In some implementations, the auxiliary moving components and/or services comprise protective packaging, disassembly, and/or reassembly, and/or other auxiliary moving components and/or services. For example, a television may need protective wrapping to prevent damage during a move.

In some implementations, the determination of whether auxiliary moving components and/or services are required may be adjusted. An adjustment may be made by a user, a moving services provider, and/or others. An adjustment may include adding and/or removing auxiliary components and/or services, for example, and/or other adjustments. Continuing with the example above, the television may need a specific type of protective wrapping. The user and/or the moving services provider may note this specific type of protective wrapping via an adjustment to the list of required actions indicating which auxiliary moving components and or services are required for the television (e.g., the television requires bubble wrap and special care to move).

Tag component 111 may be configured to generate one or more identification tags. The identification tags may be generated for the individual elements, and/or a group of elements. For example, tag component 111 may be configured to generate identification tags for the individual elements (e.g., a tag may be generated for a television, a different tag may be generated for a couch, etc.). In some implementations, tag component 111 may be configured to generate a single identification tag for a group of elements (e.g., one tag may be generated for all elements such as packing material, furniture, etc., in a room; one tag may be generated for a group of dishes, etc.). An identification tag may be an electronic representation of an element. The identification tags may comprise an image and/or other representation of a given individual element and/or a unique identification code for the given individual element, and/or other information. For example, a tag may be generated for and/or be an electronic representation of a couch. The tag may include different images of the couch from different angles, a code that individually identifies the couch, and/or other information. The code may be a scannable barcode, a list of numbers that uniquely identify the couch, a QR code, and/or other codes. A tag may be configured such that the code included in the tag may be scanned by scanning components of a computing platform (e.g., a smartphone) associated with the user, the moving services provider, a driver/crewmember, and/or others.

In some implementations, a tag may be adjusted by a user, a moving services provider, and/or others. In some implementations, an adjustment may comprise adding and/or removing identification tags, adding and/or removing images associated with one or more individual identification tags, changing images associated with the identification tags, and/or other adjustments. For example, a user may prefer a different picture of the couch described above. The user may change the image of the couch included in the tag. As another example, tag component 111 may generate individual tags for individual items such as plates, cups, etc. The user and/or the moving services provider may prefer that tag component 111 generate only one tag for the group of plates, the group of cups, etc. The user and/or the moving services provider may adjust the tags in this and other ways.

In some implementations, the identification tags may be electronic and configured to be printed (and/or otherwise physically created) and physically attached to corresponding individual elements. In some implementations, a printed unique identification code included in a given tag is configured to be scanned by a computing device associated with the user and/or the moving services provider to automatically identify a corresponding individual element (and an associated user record that identifies the user) responsive to the scan. In some implementations, the identification tags are configured to be printed before a move with a laser and/or inkjet printer, with a mobile and/or Bluetooth printer, a thermal printer, and/or other printers. For example, tags may be printed and attached to various elements by a user before move. The tags may be printed by a user on the user's home printer, for example, on adhesive paper. This example is not intended to be limiting. Alternatively and/or additionally, the tags may be printed by the moving services provider on adhesive paper or something similar, given to the driver/crew, who then attach the tags to corresponding elements at a premises before the elements are moved. The tags may also be printed by the driver/crew. The tags may be easily removed once the elements have been moved to a new location, for example.

Communication component 112 may be configured to provide the list of required actions, the auxiliary moving components and/or services, the identification tags, and/or other information to the moving services provider. In some implementations, this may include printing or causing printing of the tags, one or more documents associated with the list of required actions, and/or other documents. The one or more documents associated with the list of required actions may include a bill of lading, a loading confirmation document, and unloading confirmation document, a military moving form, a scale ticket, and/or other documents. Such documents may also include but are not limited to: updated estimate(s) based on changes to inventory and/or requested services/materials, a notice of damage, an item condition report, a crewmember timesheet, a weight ticket, a liability waiver, a notice of additional services performed, and/or other documents.

Communicating may include emailing, texting, and/or other messaging. Communicating may be wired and/or wireless. Communicating may include uploading, downloading, and/or other data transfer. Communicating may be facilitated by one or more components such as transceivers, data ports, etc., included in server 102, external resources 124, user computing platform 104, moving services provider computing platform 105, driver/crew computing platform 107, and or other components.

Interaction component 113 may be configured to timestamp, geostamp, and/or otherwise identify interactions by the user and/or the moving services provider. Interactions may include a user, a moving services provider, a driver/crew, and/or some other entity performing a task and/or taking some other action. The task and/or other action may be associated with the list of required actions for example, and/or other actions. In some implementations, interactions may comprise one or more of requesting authorization to adjust a price based on a change in services; confirming a quality of one or more of the individual elements, a building, vehicles, and/or surrounding area; taking payment; identifying separate shipments for a move and/or confirming what is in a shipment and where the shipment is going; adding, removing, and/or confirming packing material and/or services; adding, removing, and/or confirming storage services; and/or other interactions. Attributes may be added to the identified elements in the form of electronic entries stored in computer memory. Such attributes can include an element's condition, who packed the container that the element is in, whether the element is high value, assignment of a serial number of the element, assignment of a serial number for the box, and shipment information for moves with multiple destinations.

In some implementations, time stamping may include associating a time of day and/or date with a specific interaction. Geostamping may include associating a particular geographic location with a specific interaction. The geographic location may be defined by for example, latitude and/or longitude, a map location, and/or other definitions. Userstamping may include, for example, identifying the user(s) that performed certain actions and/or created a specific activity. For example, interaction component 113 may timestamp (associate a time of day and a date) a payment from a user to the moving services provider. As another example, interaction component 113 may geostamp a fully loaded set of elements responsive to a driver/crew member indicating (via a computing platform 107) that loading is complete. As a third example, interaction component 113 may userstamp an indication that the user packed one or more of the inventory items (elements).

There are many ways that time stamping, geostamping, and/or userstamping may be useful. For example, for lost and/or misplaced items if item is lost in transit, a user can find out where was it last scanned (that will help the moving services company reduce the search area/logistics). Similarly, one can also find when it was last scanned and who last scanned it. For user level performance monitoring—the system may be configured to identify if specific people are packing/loading items in a truck that end up damaged. For damage identification—if the time stamp/geo stamp shows damage with pictures it may be helpful for (insurance) claims purposes. Time stamping and/or geostamping may facilitate the ability of user who is moving to track their items so the user knows where their items are. Time stamping, geostamping, and/or userstamping may also provide transparency in operations and/or help monitor a move pro-actively. These examples are not intended to be limiting.

In some implementations, interaction component 113 may be configured to determine whether one or more items on the list of required actions was not completed, and generate a warning responsive to one or more of the items on the list of required actions not being completed. This may include comparing various interactions with the list of required actions. Interaction component 113 may identify differences between the interactions and the list of required actions based on this comparison. A warning may comprise an email, text message, call, and/or other notification that at least one item on the list of required actions was not completed. The warning may be sent to the user, the moving services provider, the driver/crew, and/or others.

User computing platform(s) 104, moving services provider computing platforms 105, driver/crew computing platforms 107, and/or other computing devices may be configured to provide interfaces between users (e.g., users requesting moving services), moving services providers, a driver/crew, and/or system 100. In some implementations, individual platforms 104, 105, 107, may be and/or are include desktop computers, laptop computers, tablet computers, smartphones, and/or other computing devices. A computing platform 104, 105, 107 may be configured to provide information to and/or receive information from users, moving services providers, drivers/crews, and/or others. For example, a computing platform 104 may be configured to present a graphical user interface to a user to display a moving app, facilitate entry and/or selection of information related to the items the user intends to move (e.g., as described herein), and/or for other purposes. In some implementations, the graphical user interface includes a plurality of separate interfaces associated with platform 104, processor 128, external resources 124, and/or other components of system 100; multiple views and/or fields configured to convey information to and/or receive information from users (e.g., as described herein); and/or other interfaces.

In some implementations, computing platforms 104, 105, 107, may include one or more processors, electronic storage, and/or other components that allow them to function as described herein. In some implementations, computing platforms 104, 105, 107 are connected to a network (e.g., the internet). The connection to the network may be wireless or wired. For example, one or more processors 128 may be located in a remote server (e.g., server 102) and may wirelessly cause display of a graphical user interface to a user on a computing platform 104 associated with the user, a computing platform 105 associated with a moving services provider, a computing platform 107 associated with a driver/crew, and/or on other computing devices.

In some implementations, a given computing platform may include one or more interface devices. Interface devices suitable for inclusion in an individual computing platform 104, 105, 107 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that an individual computing platform 104, 105, 107 includes a removable storage interface. In this example, information may be loaded into a computing platform 104, 105, 107, from removable storage (e.g., a flash drive, a removable disk, etc.) that enables customizing of the implementation of computing platforms 104, 105, 107, and/or system 100. Other exemplary input devices and techniques adapted for use with computing platforms 104, 105, 107, include, but are not limited to, an RS-232 port, RF link, an IR link, a modem (telephone, cable, etc.) and/or other devices.

External resources 124 include components that facilitate communication of information such as a network (e.g., the internet), electronic storage, equipment related to Wi-Fi technology, equipment related to Bluetooth® technology, data entry devices, sensors, scanners, one or more servers, and/or other resources. External resources 124 may be configured to communicate with server 102 and/or processor 128, electronic storage 126, user computing platform 104, moving services provider platform 105, driver/crew computing platform 107, and/or other components of system 100 via wired and/or wireless connections, via a network (e.g., a local area network and/or the internet), via cellular technology, via Wi-Fi technology, and/or via other resources. In some implementations, some or all of the functionality attributed herein to external resources 124 may be provided by resources included in other components of system 100.

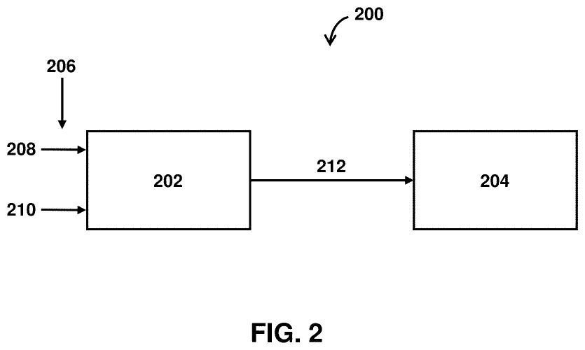

In some implementations, one or more of components 108-113 may form an artificial intelligence model. The model may be included in a larger Al framework. FIG. 2 illustrates an artificial example intelligence (Al) framework 200 that includes a model training phase 202 and a model deployment phase 204. The model may be trained (in training phase 202) to perform one or more of the operations described above. For example, the model may be trained to determine the list of required actions, arrange the list of required actions, and/or adjust the list of required actions; generate and/or adjust the identification tags; provide the list of required actions, identification tags, and/or other information to the moving services provider; automatically generate any additional documents associated with a move; timestamp, geostamp, and/or otherwise identify interactions by the user and/or the driver/crew; determine whether actions in the list of required actions have been completed; and/or perform other operations.

In some implementations, the model may be and/or in include one or more algorithms. The algorithms may include natural language processing algorithms, machine learning algorithms, neural networks, regression algorithms, and/or other algorithms. One or more algorithms may be configured to divide data such as video or audio (e.g., provided by a user such as a consumer, the moving services provider, and/or a driver/crew) into smaller segments (units) using spatial, and/or temporal constraints as well as other data such as context data. For example, a video may be divided into multiple frames and poor quality images with low lighting and/or high blur may be filtered out. Similarly, an audio input may filter out segments comprising background noise and create units of audio where a speaker (e.g., the consumer, driver, crew, etc.) is actively communicating.

One or more algorithms may be and/or include a deep neural network comprising a convolutional neural network and/or a recurrent neural network. Other algorithms such as linear regression, etc. may also be used. Multiple different algorithms may be used to process one or more different inputs. As an example, the additional documents may be generated by an algorithm based on images extracted during a pre-move survey and additional images (e.g., document damage, etc.) from the actual move. As another example, a unit of data such as an image frame may be first processed by a convolutional neural network, and the output of this network may be further processed by another algorithm such as a recurrent neural network. The output of these networks can include confidence values for the predictions, for example, and/or other information.

The one or more neural networks may be trained (i.e., whose parameters are determined) using a set of training data. The training data may include a set of training samples. Each sample may be a pair comprising an input object 208 (typically a vector, which may be called a feature vector) and a desired output value 210 (also called the supervisory signal). Training inputs may be different itemized statements of moving work, and corresponding lists of required actions, additional documents associated with a move, timestamped and/or geostamped interactions, identification tags, etc., for example. A training algorithm analyzes the training data and adjusts the behavior of the neural network by adjusting the parameters (e.g., weights of one or more layers) of the neural network based on the training data. For example, given a set of N training samples of the form {(x₁, y₁), (x₂, y₂), . . . , (x_{N}, y_{N})} such that xᵢ is the feature vector of the i-th example and yᵢ is its supervisory signal, a training algorithm seeks a neural network g: X →Y, where X is the input space and Y is the output space. A feature vector is an n-dimensional vector of numerical features that represent some object (e.g., an itemized statement of moving work as in the example above). The vector space associated with these vectors is often called the feature space. After training, the neural network may be used for making predictions using new samples (e.g., new itemized statements of moving work). It should be noted that training data is not limited to the data described above, and may include different types of input such as audio input (e.g., voice, sounds, etc.), user entries and/or selections made via a user interface, scans and/or other input of textual information, and/or other training data. The Al algorithms may, based on such training, be configured to recognize voice commands and/or input, textual input, etc.

Responsive to training being complete, the trained model may be deployed 212 as part of deployment phase 204 in framework 200. Deployment may comprise being used by server 102 (e.g., server 102 may be a deployment server) and processor 128 shown in FIG. 1 to perform one or more of the operations described herein.

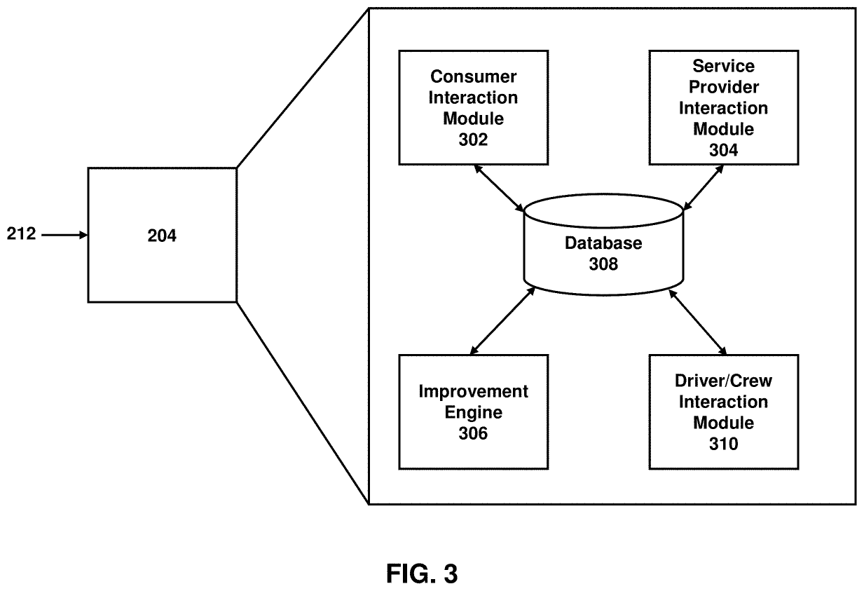

FIG. 3 illustrates an example of possible deployment phase 204 architecture 300. Architecture 300 may include one or more of a consumer interaction module 302, a service provider interaction module 304, an Al improvement engine 306, a database 308, a driver/crew interaction module 310, and/or other elements. Database 308 may be and/or be a portion of electronic storage 126 shown in FIG. 1. Various portions of each of components 108-113 shown in FIG. 1 may form one or more portions of consumer interaction module 302, service provider interaction module 304, an Al improvement engine 306, and/or driver/crew interaction module 310. For example, portions of programmed code that govern communications and/or other interactions between any of components 108-113 and a user computing platform 104 (FIG. 1) may form consumer interaction module 302. Portions of programmed code that govern communications and/or other interactions between any of components 108-113 and a moving services provider computing platform 105 (FIG. 1) may form service provider interaction module 304. Portions of programmed code that govern communications and/or other interactions between any of components 108-113 and a driver/crew computing platform 107 (FIG. 1) may form driver/crew interaction module 310. Improvement engine 306 may be formed by portions of programmed code that update and/or adjust an Al algorithm and/or predictions/determinations made by an algorithm in response to input from a user, the moving services provider, a driver/crew, and/or from other sources.

Consumer interaction module 302 may ingest data from a user and/or from other sources, store the data in database 308, analyze the data with Al models for processing, and possibly communicate the list of required actions, identification tags, and/or other information to the user. Consumer interaction module 302 may facilitate adjustment of the list of required actions, identification tags, and/or other items by the user, and/or other activities. Consumer interaction module 302 may communicate the list of required actions, the identification tags to the user, and/or provide other information to the user.

Service provider interaction module 304 may serve as an interface to allow the moving services provider to review information from users and Al analysis (e.g., the generated listed of required actions, the identification tags, etc.), make corrections and/or other adjustments if needed, and communicate with a user, a driver/crew, and/or the system (e.g., system 100).

Driver/crew interaction module 310 may serve as an interface to allow a driver/crew to review information from users and Al analysis (e.g., the generated listed of required actions, the identification tags, etc.), make corrections and/or other adjustments if needed, and communicate with a user, a driver/crew, and/or the system (e.g., system 100).

Al improvement engine 306 may combine an original analysis output from the Al (e.g., the list of required actions) with any changes made by a user, moving service provider, driver/crew, and/or other source, and provide feedback to the Al model to improve the trained model. Al improvement engine 306 may also host Al framework 200 which may runs multiple (e.g., machine learning) models to be used on the data sent from the user as well as a moving service provider.

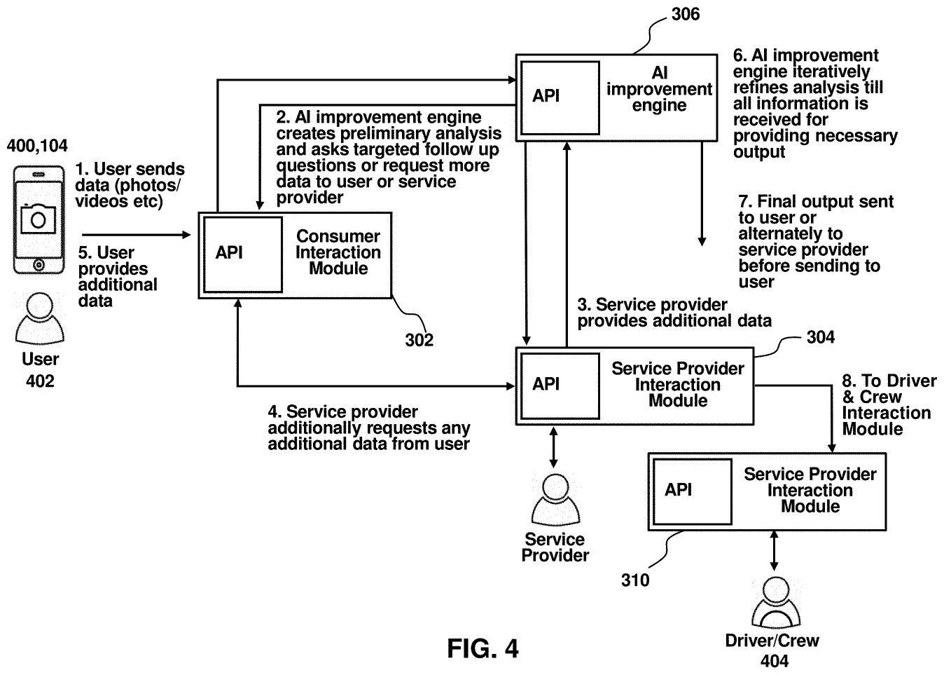

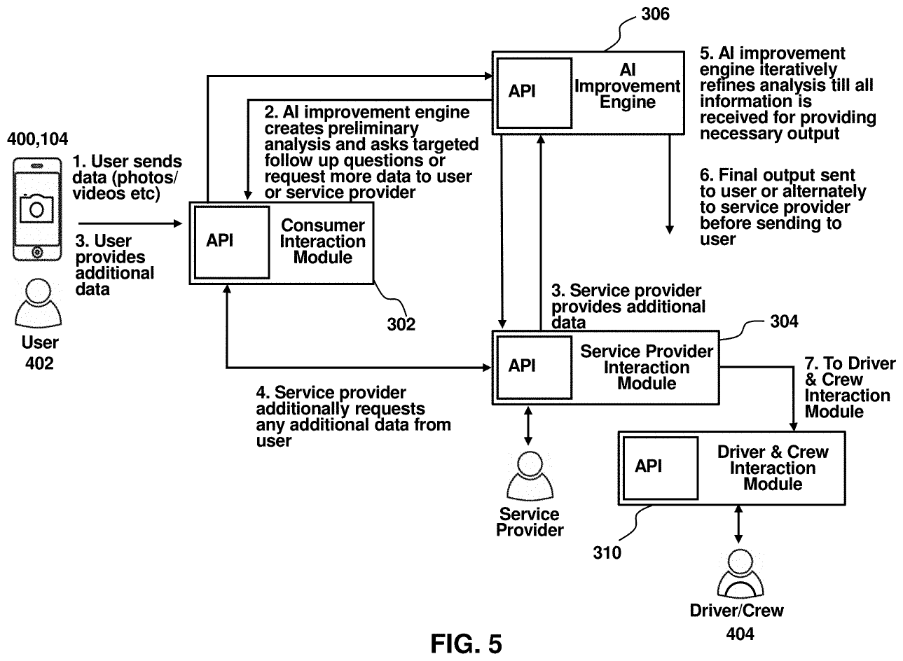

FIGS. 4 and 5 illustrate different possible iterative ways data is collected and analyzed, in accordance with one or more implementations. For example, FIGS. 4 and 5 illustrate operations ranging from original receipt of information 400 from a user 402 that is used to generate the itemized statement of moving work to communication (e.g., of a list of required actions) with a driver/crew 404. As shown in FIGS. 4 and 5, each of consumer interaction module 302, service provider interaction module 304, Al improvement engine 306, and/or driver/crew interaction module 310 may be associated with an API. In some implementations, the API's may be separate. In some implementations, these API are part of a single API generated by server 102 and/or processor 128 (FIG. 1).

FIGS. 4 and 5 illustrate a flow diagrams describing iterative ways that Al algorithms, and/or human agents may ask relevant questions based on user data (text, image, videos, etc. sent, input, or otherwise acquired by the system) to collect additional information needed to perform one or more of the operations described above. For example, FIGS. 4 and 5 may describe processes for gathering data used to determine the list of required actions, arrange the list of required actions, and/or adjust the list of required actions; generate and/or adjust the identification tags; provide the list of required actions, identification tags, and/or other information to the moving services provider; automatically generate any additional documents associated with a move; timestamp, geostamp, and/or otherwise identify interactions by the user and/or the driver/crew; determine whether actions in the list of required actions have been completed; and/or perform other operations.

FIG. 4 illustrates a process where a (pre-move) survey is performed by an end user who is moving and is interacting with a service provider (moving company). FIG. 5 illustrates an implementation where an on-site estimator is doing the survey (so the end user doesn't interact with the Al results, the service provider does). In general, these two figures are showing the process of how the end to end system would work (process flow chart): 1. a user does a survey, 2. Al performs analysis, 3. Al needs more information and questions are asked of the service provider and user to fill in the information, 4. user or service provider provides additional input, 5. a new estimate is created based on the above actions, 6. the finalized version is sent to driver and crew.

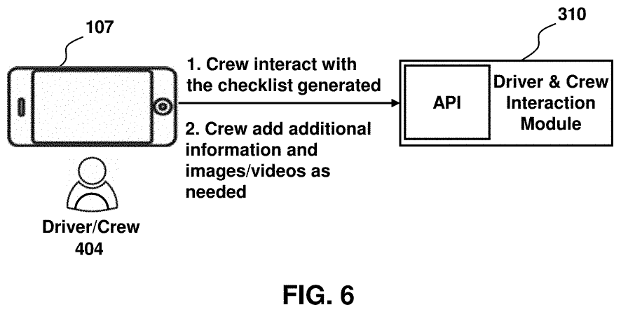

FIG. 6 illustrates driver/crew 404 interacting with driver/crew interaction module 310, in accordance with one or more implementations. As shown in FIG. 6, driver/crew 404 may interact with the list of required actions (e.g., which may have been previously sent to driver/crew 404). Driver/crew 404 may add additional information and/or images, videos, and/or other information as needed. The interaction may occur via a driver/crew computing platform 107, for example, and/or other computing devices. By way of a non-limiting example, as described above, interactions may include a driver/crew performing a task and/or taking some other action. The task and/or other action may be associated with the list of required actions for example, and/or other actions. In some implementations, interactions may comprise one or more of requesting authorization to adjust a price based on a change in services; confirming a quality of one or more of the individual elements, a building, vehicles, and/or surrounding area; taking payment; identifying separate shipments for a move and/or confirming what is in a shipment and where the shipment is going; adding, removing, and/or confirming packing material and/or services; adding, removing, and/or confirming storage services; and/or other interactions.

As another example, the driver/crew may enter and/or select additional information, images, and/or video associated with one or more of the individual elements. The driver/crew may note a status of an element and/or other information. The status of individual elements may comprise one or more of damaged, packed, loaded, unloaded, and/or other statuses. For example, a driver/crew may arrive at a premises to move the individual elements and discover that one element is damaged. The driver/crew may provide additional information to document the damage. The additional information may include pictures, video, text, and audio recording, and/or other information.

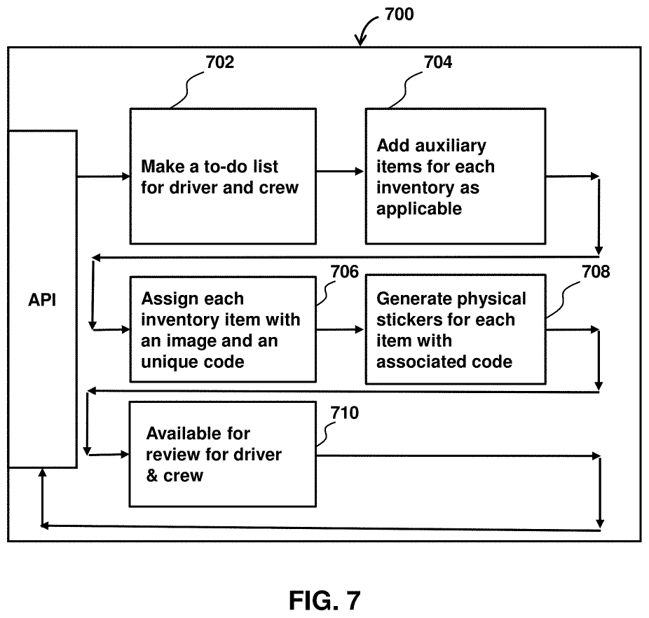

FIG. 7 illustrates an example work flow 700 comprising example operations 702, 704, 706, 708, and 710 performed by various processor components shown in FIG. 1. Together, the programming for the portions of these components that facilitate the operations listed in FIG. 7 may form the driver/crew interaction module (including the API or portion of an API) shown in FIG. 3-5, for example. This example is not intended to be limiting.

At an operation 702, a list of required actions may be determined for a moving services provider and/or a driver/crew (the driver/crew is used in this example). The required actions may be determined based on an itemized statement of moving work, and/or other information (e.g., previously generated as described herein). The required actions may comprise packing specific individual elements, loading specific individual elements, moving specific individual elements from a first location to a second location, unloading specific individual elements, unpacking specific individual elements, installing and/or removing a protective component configured to protect one or more features of a building during a move, obtaining moving assistance equipment configured to ease movement of one or more of the individual elements, and/or other required actions.

The required actions may be listed together with a picture and/or other information or a corresponding element (e.g., a chair, a couch, etc.). In some implementations, a deep learning/edge detection/tracker algorithm may look over image frames that include a given element and choose the optimal frame for displaying in the list of required actions. The image selected here can be different than the image selected in a main review interface that is optimized to minimize images, for example. In this case we know we are going to get one image per item, and we want to pick the best image (lighting, in focus, size, etc.)

At an operation 704, auxiliary items may be added as applicable for individual elements. This may include a determination of whether auxiliary moving components and/or services are required for induvial elements. In some implementations, the auxiliary moving components and/or services comprise protective packaging, disassembly, and/or reassembly, and/or other auxiliary moving components and/or services. In some implementations, the determination of whether auxiliary moving components and/or services are required may be adjusted. An adjustment may be made by a user, a moving services provider, a driver/crew, and/or others. An adjustment may include adding and/or removing auxiliary components and/or services, for example, and/or other adjustments.

In some implementations, one or more Al algorithms may be configured for identifying which auxiliary items to add. For example, bookshelves generally require book boxes. Large furniture items like armoires can require service items like a dolly or tools for disassembly/reassembly. These items may differ from what is shown in a main reviewer interface since the items are the items needed to service the job, not just the items moving/not moving. For example, the one or more Al algorithms may determine that five rolls of tape are needed given a certain mix of (packing) cartons.

At an operation 706, individual inventory items may be assigned and/or otherwise associated with a corresponding image and/or other representations (e.g., such as an icon, etc.) and a unique code. This may be and/or include generating identification tags. The identification tags may be generated for the individual elements. The identification tags may comprise an image of a given individual element and/or a unique identification code for the given individual element, and/or other information. In some implementations, a tag may be adjusted by a user, a moving services provider, and/or others. In some implementations, an adjustment may comprise adding and/or removing identification tags, adding and/or removing images associated with the identification tags, changing images associated with the identification tags, and/or other adjustments. In some implementations, the identification tags may be electronic and configured to be printed and physically attached to corresponding individual elements.

(103) In some implementations, the selected image from the list of required actions may be post-processed by one or more Al algorithms to optimize printing. For example, some implementations may use a portable grayscale or thermal printer, and in that case a full color image may not be easily recognizable when printed out. So it can be beneficial to adjust contrast, levels, hue, saturation, brightness, etc., to optimize for a grayscale or monochrome printer.

(104) At an operation 708, physical stickers for each element may be generated. The physical stickers may include the picture and the unique code, for example. This may include printing the individual identification tags. In some implementations, a printed unique identification code included in a given tag is configured to be scanned by a computing device associated with the user, the moving services provider, and/or the driver/crew to automatically identify a corresponding individual element responsive to the scan. In some implementations, the identification tags are configured to be printed before a move with a laser and/or inkjet printer, with a mobile and/or Bluetooth printer, a thermal printer, and/or other printers.

At an operation 710, the list of required actions, the auxiliary items, the physical stickers, and/or other information may be communicated to the driver/crew for review. In some implementations, one or more of the Al algorithms may be configured such that the list of required actions may be allocated to drivers/crew members based on past performance. For example, historical data could be used to determine certain employees are more effective at certain tasks and assign them tasks that they are best suited for. This would help improve move quality by ensuring the best person available is on each task.

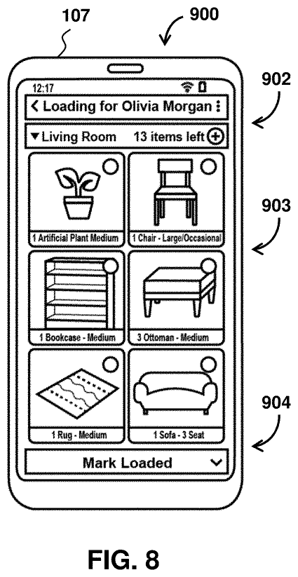

FIG. 8-14 illustrate several practical examples of the present system and method in use.

FIG. 8 illustrates a checklist of elements that need to be packed, loaded, or unloaded. The checklist of elements that need to be packed may form at least a portion of a list of required actions generated by actions component 109 (FIG. 1) and/or service provider interaction module 304 (FIG. 3-5). In this example, the individual elements include a plant, a chair, a bookcase, an ottoman, a rug, and a sofa. The individual elements are group by the room where they are located—the living room. The marking of individual elements as packed, loaded, or unloaded may be performed via one or more views 902, 903, 904 of a graphical user interface 900 running on a computing platform, for example. In this example, the computing platform may be a driver/crew computing platform 107. The individual elements may be marked as packed, loaded, or unloaded by touching the touchscreen of computing platform 107 at a specific element, for example.

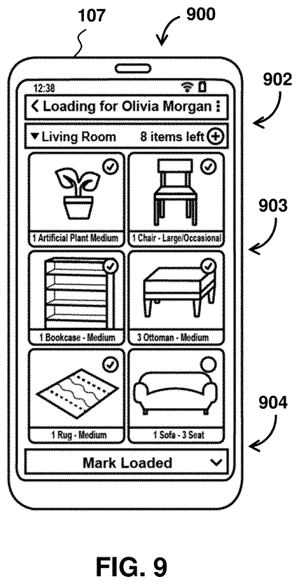

FIG. 9 illustrates marking individual elements as packed, loaded, or unloaded. In this example (as in FIG. 8), the individual elements include a plant, a chair, a bookcase, an ottoman, a rug, and a sofa. The individual elements are again shown as grouped by the room where they are located—the living room. The marking of individual elements as packed, loaded, or unloaded may be performed via one or more views 902, 903, 904 of a graphical user interface 900 running on a computing platform, for example (e.g., and facilitated by interaction component 113 shown in FIG. 1 and/or driver/crew interaction module 310 shown in FIG. 3-5). In this example, the computing platform may again be a driver/crew computing platform 107. The driver/crew member may select the “mark loaded” option from the drop down menu in view 904 and then touch each individual element they want marked as loaded. As each item is marked, a check circle mark and/or other indicator may appear at or near the marked element. As individual elements are marked loaded, a number of items left to load may be reduced (e.g., a number of a remaining list of required actions is reduced).

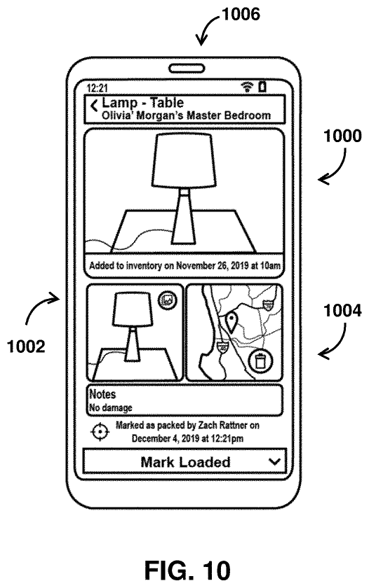

FIG. 10 illustrates timestamping, geostamping, and userstamping interactions. The timestamping and geostamping may be shown via one or more views 1000, 1002, 1004 of a graphical user interface 1006 running on a computing platform, for example. In this example, the computing platform may be a user computing platform 104. As shown in FIG. 10, a lamp (pictured) may be packed by a user. Interactions may including adding the lamp to the user's inventor of elements the user wants to move, and marking the lamp as packed, in this example. View 1000 illustrates the lamp and notes the lamp has been added to inventory on a given date at a given time. View 1004 illustrates a map and notes where the lamp was marked as packed. FIG. 10 also illustrates other fields configured to facilitate entry and/or selection of information that indicates whether the lamp is damaged and/or loaded. These operations may be facilitated by interaction component 113 (FIG. 1), consumer interaction module 302 (FIG. 3-5), and/or other components of system 100 (FIG. 1).

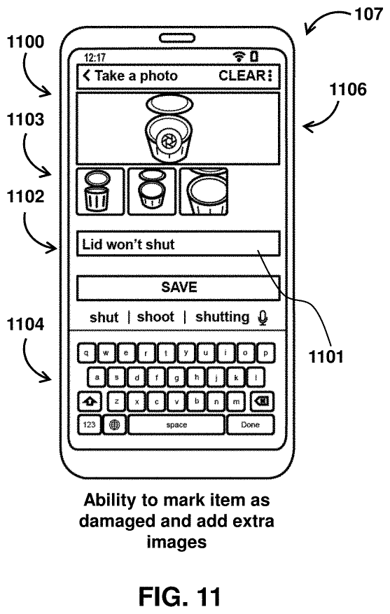

FIG. 11 illustrates marking 1101 an element as damaged, and adding extra images 1103, in accordance with one or more implementations. The marking and adding extra images may be performed via one or more views 1100, 1102, 1104 of a graphical user interface 1106 running on a computing platform, for example. In this example, the computing platform may be a driver/crew computing platform 107. Computing platform 107 may include a camera, an app, and/or other components that facilitate taking and adding the extra images 1103, entering and/or selecting text (e.g., annotations for the images), and/or other operations. In this example, the images are taken to document a trashcan with a lid that will not shut. In other embodiments, the system may determine elements (e.g., ones being moved or ones being not moved) from the captured images utilizing the machine learning algorithms described herein. Utilizing the graphical user interface 1106, annotations may be added for any of the elements (i.e., either those moving, or not moving, or both). The determination of whether an element is moving or non-moving can be performed by the machine learning algorithms (e.g., identifying non-moving structural objects) or based on input from a user (e.g., creating a bounding box around an object and tagging it as moving/non-moving).

In this example, the driver/crew may enter and/or select additional information, images 1103, and/or video associated with one or more of the individual elements (e.g., the trash can). The driver/crew may note a status of an element (the trash can) and/or other information. The status of the trash can may comprise damaged, for example. The additional pictures 1103, video, and/or other information may document the damage. The additional information may include pictures, video, text, and audio recording, and/or other information. In this example, these operations may be facilitated by adjustment component 110 (FIG. 1), driver/crew interaction module 310 (FIG. 3-5), and/or other components of system 100 (FIG. 1).

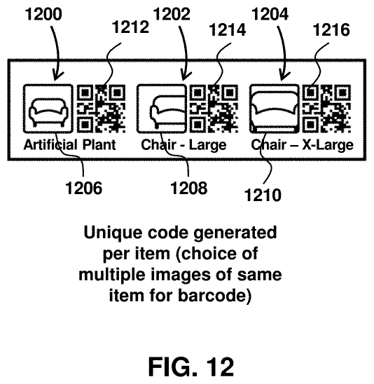

FIG. 12 illustrates three different examples of possible identification tags 1200, 1202, and 1204. Each tag includes a picture 1206, 1208, 1210 and a unique code 1212, 1214, 1216 for a corresponding element (three different pictures of the same chair in this example) a user wants to move. In this example, codes 1212, 1214, and 1216 may be the same since the same chair is associated with each tag. In this example, tags 1200, 1202, and 1204 are arranged based on the rooms of a user's house (in this example, this chair is located in Olivia Morgan's lobby). Tags 1200, 1202, and/or 1204 may be configured to be printed and/or attached to the chair shown in pictures 1206, 1208, and 1210. As described above, these and other tags may be generated by tag component 111 (FIG. 1) and/or other components of system 100 (FIG. 1).

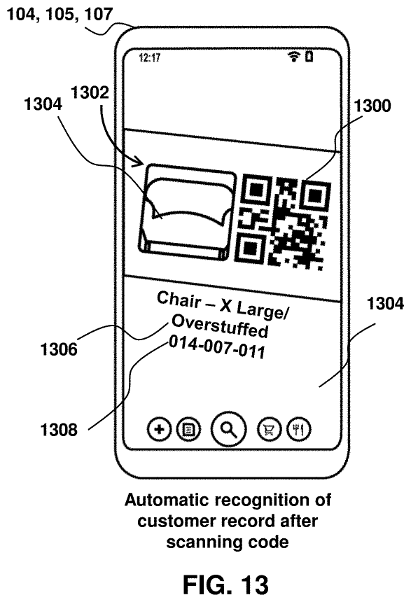

FIG. 13 illustrates automatic recognition of a code 1300 on an identification tag 1302. In this example, tag 1302 was previously placed on a chair 1304. Tag 1302 includes a picture of chair 1304, a description 1306, and a second code 1308, in addition to code 1300, in this example. Code 1300 may be scanned with a scanner (e.g., a scanning app and a camera) included in a user computing platform 104, a moving services provider computing platform 105, and/or a driver/crew computing platform 107, for example. After scanning, an associated user record may be identified. In some implementations, a log is created that records the fact that a certain element was scanned and uploaded to the database. This creates an audit trail. The address of the associated user record may be automatically identified and the person who is scanning can identify which user the element belongs to. These operations may be facilitated by tag component 111 (FIG. 1) and/or other components of system 100 (FIG. 1).

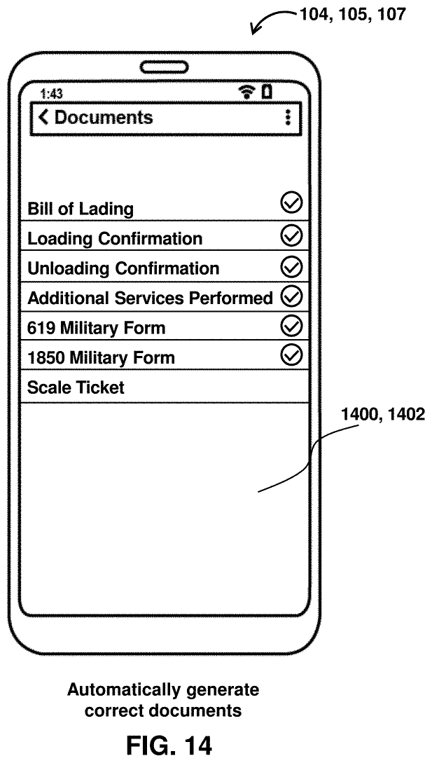

FIG. 14 illustrates a view 1400 of a graphical user interface 1402 presented via a user computing platform 104, a moving services provider computing platform 105, and/or a driver/crew computing platform 107 that shows a list of automatically generated additional documents associated with a move (e.g., generated as described above related to FIG. 1-6). In this example, the additional documents comprise a bill of lading, a loading confirmation document, an unloading confirmation document, a document that lists additional services performed, two different military forms (e.g., if the present system and/or method were used by a member of the military to make a move), and a scale ticket. These examples are not intended to be limiting. In some implementations, the additional documents may be generated and/or communicated by communications component 112 (FIG. 1) and/or other components of system 100 (FIG. 1), for example.

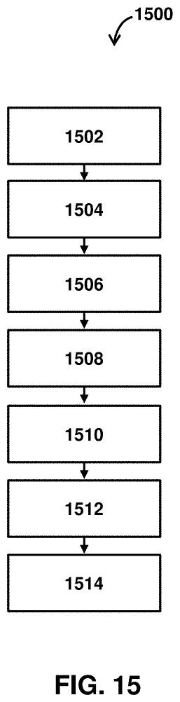

FIG. 15 illustrates a method 1500 for providing interactive moving services, in accordance with one or more implementations. The operations of method 1500 presented below are intended to be illustrative. In some implementations, method 1500 may be accomplished with one or more additional operations not described, and/or without one or more of the operations discussed. Additionally, the order in which the operations of method 1500 are illustrated in FIG. 15 and described below is not intended to be limiting.

In some implementations, method 1500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1500 in response to instructions stored electronically on an electronic storage medium. The one or more processing devices may include one or more devices configured through hardware, firmware, and/or software to be specifically designed for execution of one or more of the operations of method 1500. For example, method 1500 may be performed by one or more hardware processors similar to and/or the same as processor(s) 128 of server 102 described above. The one or more hardware processors may be configured by machine readable instructions, and/or other instructions.

At an operation 1502, an itemized statement of moving work to be performed by a moving services provider may be received. The itemized statement of moving work may comprise individual elements a user intends to move, services needed for moving the elements, and/or other information. In some implementations, the individual elements comprise furniture, appliances, dishes, utensils, wall hangings, art, rugs, light fixtures, and/or other elements. Operation 1502 may be performed by one or more hardware processors the same as or similar to processor 128 (as described in connection with FIG. 1), in accordance with one or more implementations.

At an operation 1504, a list of required actions may be determined. The list of required actions may be determined for the moving services provider and/or others. The required actions may be determined based on the itemized statement of moving work, and/or other information. The required actions may comprise packing specific individual elements, loading specific individual elements, moving specific individual elements from a first location to a second location, unloading specific individual elements, unpacking specific individual elements, installing and/or removing a protective component configured to protect one or more features of a building during a move, obtaining moving assistance equipment configured to ease movement of one or more of the individual elements, and/or other required actions. In some implementations, the list of required actions may be arranged by user, by areas within a premises associated with a given user, and/or by other factors. In some implementations, the premises comprises a building, and the areas within the premises comprise rooms. In some implementations, the list of required actions may be synced from a pre-move inventory that was completed by a user, the moving services provider, and/or a third party. Operation 1504 may be performed by one or more hardware processors the same as or similar to processor 128 (as described in connection with FIG. 1), in accordance with one or more implementations.

At an operation 1506, the list of required actions may be adjusted. Adjustments may be received from the moving services provider and/or a user. The one or more hardware processors may be configured such that the adjustments are entered and/or selected by the moving services provider via a user interface associated with the moving services provider and/or by the user via a user interface associated with the user, for example. In some implementations, an adjustment may include adding and/or removing required actions, for example, and/or other adjustments. In some implementations, adjusting may include receiving entry and/or selection of additional information, images, and/or video associated with one or more of the individual elements from the moving services provider, for example. In some implementations, the additional information may comprise a status of individual elements, and/or other information. The status of individual elements may comprise one or more of damaged, packed, loaded, unloaded, and/or other statuses. Operation 1506 may be performed by one or more hardware processors the same as or similar to processor 128 (as described in connection with FIG. 1), in accordance with one or more implementations.

At an operation 1508, a determination of whether auxiliary moving components and/or services are required for individual elements in the list of required actions may be made. In some implementations, the auxiliary moving components and/or services comprise protective packaging, disassembly, and/or reassembly, and/or other auxiliary moving components and/or services. In some implementations, the determination of whether auxiliary moving components and/or services are required may be adjusted. An adjustment may be made by a user, a moving services provider, and/or others. An adjustment may include adding and/or removing auxiliary components and/or services, for example, and/or other adjustments. Operation 1508 may be performed by one or more hardware processors the same as or similar to processor 128 (as described in connection with FIG. 1), in accordance with one or more implementations.

At an operation 1510, identification tags may be generated. The identification tags may be generated for the individual elements. The identification tags may comprise an image of a given individual element and/or a unique identification code for the given individual element, and/or other information. In some implementations, a tag may be adjusted by a user, a moving services provider, and/or others. In some implementations, an adjustment may comprise adding and/or removing identification tags, adding and/or removing images associated with the identification tags, changing images associated with the identification tags, and/or other adjustments. In some implementations, the identification tags may be electronic and configured to be printed and physically attached to corresponding individual elements. In some implementations, a printed unique identification code included in a given tag is configured to be scanned by a computing device associated with the user and/or the moving services provider to automatically identify a corresponding individual element responsive to the scan. In some implementations, the identification tags are configured to be printed before a move with a laser and/or inkjet printer, with a mobile and/or Bluetooth printer, a thermal printer, and/or other printers. Operation 1510 may be performed by one or more hardware processors the same as or similar to processor 128 (as described in connection with FIG. 1), in accordance with one or more implementations.

At an operation 1512, the list of required actions, the auxiliary moving components and/or services, the identification tags, and/or other information may be provided to the moving services provider. In some implementations, operation 1512 may include printing or causing printing of the tags, one or more documents associated with the list of required actions, and/or other documents. Operation 1512 may be performed by one or more hardware processors the same as or similar to processor 128 (as described in connection with FIG. 1), in accordance with one or more implementations.

At an operation 1514, interactions by the user and/or the moving services provider may be timestamped, geostamped, and/or userstamped. In some implementations, interactions may comprise one or more of requesting authorization to adjust a price based on a change in services; confirming a quality of one or more of the individual elements, a building, vehicles, and/or surrounding area; taking payment; identifying separate shipments for a move and/or confirming what is in a shipment and where the shipment is going; adding, removing, and/or confirming packing material and/or services; adding, removing, and/or confirming storage services; and/or other interactions. In some implementations, operation 1514 may include determining whether one or more items on the list of required actions was not completed, and generating a warning responsive to one or more of the items on the list of required actions not being completed. Operation 1514 may be performed by one or more hardware processors the same as or similar to processor 128 (as described in connection with FIG. 1), in accordance with one or more implementations.

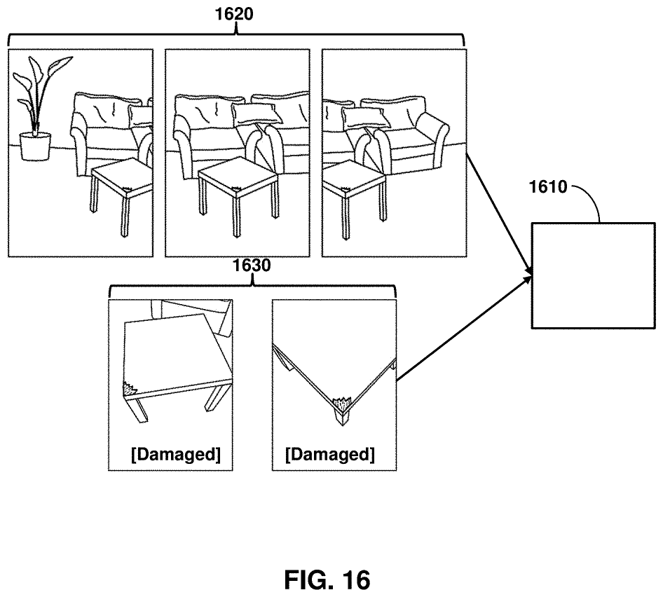

FIGS. 16-18 illustrate an Al module determining whether an object is damaged based on available images. In one implementation as shown in FIG. 16, the Al module 1610 may be trained to detect and identify damaged objects may accept as input one or more images 1620 taken at time “A”. These images may be recorded by the end user, the moving services provider during an on-site visit, a 3rd party provider as part of another service (e.g., crating estimation, insurance coverage estimation) or crew. The Al module may also take as input another set of images 1630 taken at time “B” along with annotation that the object is damaged in such images. The annotation can include a binary damaged/not damaged or even include the type of damage (e.g., scratches, dents, burns, etc.). These set of images may be recorded by the user, crew (e.g., during move day) or during a 3rd party inspection. Based on the two sets of images along with annotation, the Al module may learn to detect damage using machine learning, in a manner similar to that described herein. Such annotated images can form part of a training library, which may be used to train the Al module to identify damaged objects.

These procedures are similar to the disclosed object identification methods but may include the Al module either detecting damage outright (e.g., a table missing a leg as compared to images in a training library of similar tables with all their legs) or analyzing portions of the image to detect image portions indicative of damage (e.g., scratches, discoloration, warping, etc.) that are not found in training images of similar undamaged objects.

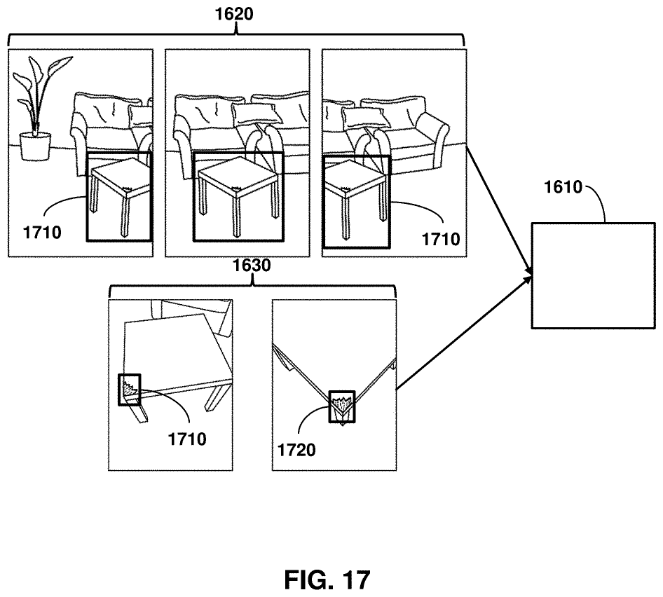

As shown in FIG. 17, in some implementations, the Al module 1610 may also additionally accept an object identification tag (e.g., identifying the damaged object) such as bounding boxes 1710 or segmentation mask. It can also accept damage identification tags (e.g., directly identifying the damage) such as bounding boxes 1720, X/Y co-ordinates or segmentation masks.

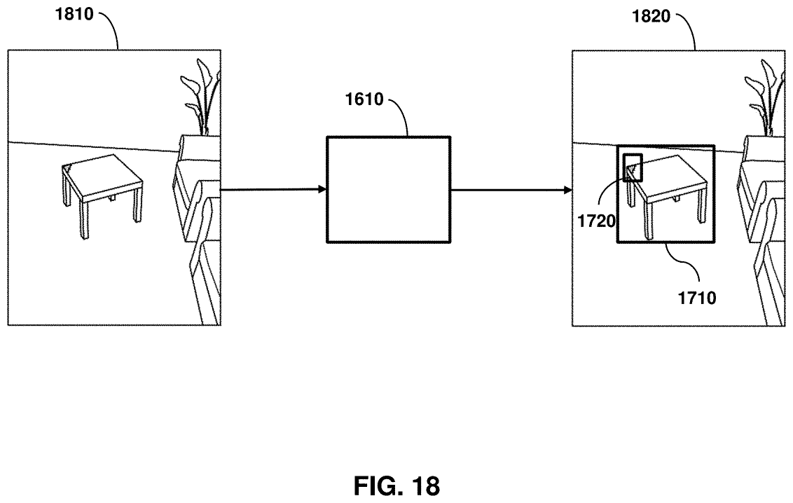

As shown in FIG. 18, the trained Al module 1610 may then take any image 1810 and predict one or more of the following: whether damaged item(s) are present in an image, probability prediction of damage, the type of damages observed, the type of object and identity of the objects that are damaged, and the location(s) of damage in the image 1820-X/Y coordinates, bounding boxes (1710,1720), masks.

As one specific working example, which is not necessary in any particular implementation, when the mover captures a photo of an item, the output layer of the classification network may provide a vector of confidence values between 0 and 1. The position of the number in the vector identifies which category it belongs to. For example: [0.3, 0.5, 0.2] could map to dented: 30%, scratched: 50%, burned: 20%. Accordingly, the system may suggest damage annotations of for results from all output layers over a certain confidence threshold. Continuing with the example above, with a confidence threshold of 25%, the system may provide an indication (e.g., in the form of graphical output on a device, annotation in an inventory listing of the item, etc.) that the item is dented and scratched. The confidence threshold may be set by a user or automatically determined by the Al module based on analysis of past user classifications of damage.

Examples of use cases for the Al module can include: automatically flagging items as damaged right after a pre-move survey (damage annotation doesn't have to wait for the move crew to go on-site), automatically adjusting the insurance coverage for the object and/or property (amount covered, insurance premium), automatically flagging items for special handling, or automatically assigning or update a replacement cost value for the object.

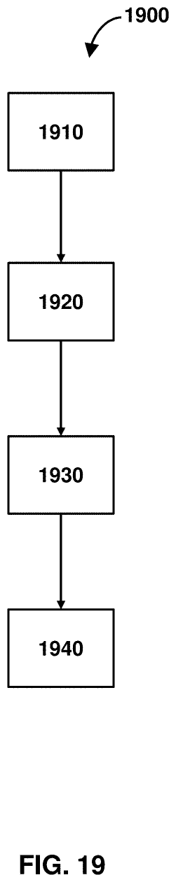

FIG. 19 illustrates an algorithm 1910, which may be implemented in a system or as a computer-implemented method, for an Al module determining whether an object is damaged based on available images.

At operation 1910, an Al module may receive an image of an object acquired, for example, by an image capture device.

At operation 1920, the Al module may compare at least a portion of the image corresponding to the object to images in a training library.

At operation 1930, the Al module may determine, based on the comparing, whether the portion of the image indicates that the object is damaged. In some implementations, the operations may include receiving one or more bounding boxes surrounding the portion of the image, where the determining is further based on the portion of the image inside the one or more bounding boxes.

At operation 1940, the system may generate an indication of the determined damage. In some implementations, the operations may include comparing the portion of the image to images of known damage types present in the training library. The system may then determine a type of damage present with the object based on the comparing with the known damage types.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

In the following, further features, characteristics, and exemplary technical solutions of the present disclosure will be described in terms of items that may be optionally claimed in any combination:

Item 1: An interactive moving services method, the method performed by one or more hardware processors configured by machine readable instructions, the method comprising: receiving an itemized statement of moving work to be performed by a moving services provider, the itemized statement of moving work comprising individual elements a user intends to move and services needed for moving the elements; determining a list of required actions for the moving services provider, the required actions determined based on the itemized statement of moving work; generating identification tags for the individual elements, the identification tags comprising an image of a given individual element and/or a unique identification code for the given individual element; and providing the list of required actions and/or the identification tags to the moving services provider.

Item 2: The method of any one of the preceding items, further comprising determining whether auxiliary moving components and/or services are required for the individual elements; and providing the list of required actions, the auxiliary moving components and/or services, and the identification tags to the moving services provider.

Item 3: The method of any one of the preceding items, wherein the individual elements comprise furniture, appliances, dishes, utensils, wall hangings, art, rugs, and/or light fixtures.

Item 4: The method of any one of the preceding items, wherein the required actions comprise packing specific individual elements, loading specific individual elements, moving specific individual elements from a first location to a second location, unloading specific individual elements, unpacking specific individual elements, installing and/or removing a protective component configured to protect one or more features of a building during a move, and/or obtaining moving assistance equipment configured to ease movement of one or more of the individual elements.

Item 5: The method of any one of the preceding items, wherein the identification tags are electronic and configured to be printed and physically attached to corresponding individual elements.

Item 6: The method of any one of the preceding items, wherein a printed unique identification code is configured to be scanned by a computing device associated with the user and/or the moving services provider to automatically identify a corresponding individual element responsive to the scan.

Item 7: The method of any one of the preceding items, wherein the identification tags are configured to be printed before a move with a laser and/or inkjet printer, with a mobile and/or Bluetooth printer, and/or a thermal printer.

Item 8: The method of any one of the preceding items, further comprising receiving adjustments to the list of required actions and/or the identification tags by the moving services provider and/or a user, the one or more hardware processors configured such that the adjustments are entered and/or selected by the moving services provider via a user interface associated with the moving services provider and/or by the user via a user interface associated with the user.

Item 9: The method of any one of the preceding items, wherein the adjustments comprise adding or removing actions from the list of required actions, adding or removing auxiliary moving components, adding or removing identification tags, adding or removing images associated with the identification tags, and/or changing images associated with the identification tags.

Item 10: The method of any one of the preceding items, further comprising receiving entry and/or selection of additional information, images, and/or video associated with one or more of the individual elements from the moving services provider.

Item 11: The method of any one of the preceding items, wherein the additional information comprises a status of individual elements.

Item 12: The method of any one of the preceding items, wherein the status of individual elements comprises one or more of damaged, packed, loaded, or unloaded.

Item 13: The method of any one of the preceding items, further comprising timestamping and/or geostamping interactions by the moving services provider and/or a user.

Item 14: The method of any one of the preceding items, wherein interactions comprise one or more of requesting authorization to adjust a price based on a change in services; confirming a quality of one or more of the individual elements, a building, vehicles, and/or surrounding area; taking payment; identifying separate shipments for a move and/or confirming what is in a shipment and where the shipment is going; adding, removing, and/or confirming packing material and/or services; or adding, removing, and/or confirming storage services.

Item 15: The method of any one of the preceding items, wherein the list of required actions is arranged by user, and/or by areas within a premises associated with a given user.

Item 16: The method of any one of the preceding items, wherein the premises comprises a building, and the areas within the premises comprise rooms.

Item 17: The method of any one of the preceding items, further comprising determining whether auxiliary moving components and/or services are required for the individual elements; and wherein the auxiliary moving components and/or services comprise protective packaging, disassembly, and/or reassembly.

Item 18: The method of any one of the preceding items, further comprising facilitating printing of one or more documents associated with the list of required actions and the identification tags.

Item 19: The method of any one of the preceding items, further comprising determining whether one or more items on the list of required actions was not completed, and generating a warning responsive to one or more of the items on the list of required actions not being completed.

Item 20: The method of any one of the preceding items, wherein the list of required actions is synced from a pre-move inventory that was completed by a user, the moving services provider, and/or a third party.

Item 21: The method of any one of the preceding items, wherein the one or more hardware processors are further configured to: determine a non-moving element from items identified from the images; and add an annotation to the non-moving element utilizing a graphical user interface.

Item 22: An interactive moving services system, the system comprising one or more hardware processors configured by machine readable instructions to receive, at an Al module, an image of an object acquired by an image capture device; compare, by the Al module, at least a portion of the image corresponding to the object to images in a training library; determine, by the Al module, based on the comparing, whether the portion of the image indicates that the object is damaged; and generate an indication of the determined damage.

Item 23: The system of any one of the preceding items, the one or more hardware processors are further configured to: receive one or more bounding boxes surrounding the portion of the image, wherein the determining is further based on the portion of the image inside the one or more bounding boxes.

Item 24: The system of any one of the preceding items, the one or more hardware processors are further configured to: compare the portion of the image to images of known damage types present in the training library; and determine a type of damage present with the object based on the comparing with the known damage types.

Item 25: A method performed by one or more hardware processors configured by machine readable instructions, the method comprising operations of any of items 1-24.

Item 26: A non-transitory machine-readable medium storing instructions which, when executed by at least one programmable processor, cause the at least one programmable processor to perform operations comprising those of any of items 1-24.

Item 26: A system comprising at least one programmable processor and non-transitory machine-readable medium storing instructions which, when executed by the at least one programmable processor, cause the at least one programmable processor to perform operations comprising those of any of items 1-24.

What is claimed is:

1. An interactive moving services system, the system comprising one or more hardware processors configured by machine readable instructions to:
receive an itemized statement of moving work to be performed by a moving services provider, the itemized statement of moving work comprising individual elements a user intends to move and services needed for moving the elements;
determine a list of required actions for the moving services provider, the required actions determined based on the itemized statement of moving work;
generate identification tags for the individual elements, the identification tags comprising an image of a given individual element and/or a unique identification code for the given individual element; and
provide the list of required actions and/or the identification tags to the moving services provider.

2. The system of claim 1, wherein the one or more hardware processors are further configured to determine whether auxiliary moving components and/or services are required for the individual elements; and provide the list of required actions, the auxiliary moving components and/or services, and the identification tags to the moving services provider.

3. The system of claim 1, wherein the required actions comprise packing specific individual elements, loading specific individual elements, moving specific individual elements from a first location to a second location, unloading specific individual elements, unpacking specific individual elements, installing and/or removing a protective component configured to protect one or more features of a building during a move, and/or obtaining moving assistance equipment configured to ease movement of one or more of the individual elements.

4. The system of claim 1, wherein the identification tags are electronic and configured to be printed and physically attached to corresponding individual elements.

5. The system of claim 4, wherein a printed unique identification code is configured to be scanned by a computing device associated with the user and/or the moving services provider to automatically identify a corresponding individual element responsive to the scan.

6. The system of claim 1, wherein the one or more hardware processors are further configured to receive adjustments to the list of required actions and/or the identification tags by the moving services provider and/or a user, the one or more hardware processors configured such that the adjustments are entered and/or selected by the moving services provider via a user interface associated with the moving services provider and/or by the user via a user interface associated with the user.

7. The system of claim 1, wherein the one or more hardware processors are configured to determine whether one or more items on the list of required actions was not completed, and generate a warning responsive to one or more of the items on the list of required actions not being completed.

8. The system of claim 1, wherein the one or more hardware processors are configured such that the list of required actions is synced from a pre-move inventory that was completed by a user, the moving services provider, and/or a third party.

9. The system of claim 1, wherein the one or more hardware processors are further configured to:
determine a non-moving element from items identified from the images; and
add an annotation to the non-moving element utilizing a graphical user interface.

10. An interactive moving services method, the method performed by one or more hardware processors configured by machine readable instructions, the method comprising:
receiving an itemized statement of moving work to be performed by a moving services provider, the itemized statement of moving work comprising individual elements a user intends to move and services needed for moving the elements;
determining a list of required actions for the moving services provider, the required actions determined based on the itemized statement of moving work;
generating identification tags for the individual elements, the identification tags comprising an image of a given individual element and/or a unique identification code for the given individual element; and
providing the list of required actions and/or the identification tags to the moving services provider.

11. The method of claim 10, further comprising determining whether auxiliary moving components and/or services are required for the individual elements; and providing the list of required actions, the auxiliary moving components and/or services, and the identification tags to the moving services provider.

12. The method of claim 10, wherein the required actions comprise packing specific individual elements, loading specific individual elements, moving specific individual elements from a first location to a second location, unloading specific individual elements, unpacking specific individual elements, installing and/or removing a protective component configured to protect one or more features of a building during a move, and/or obtaining moving assistance equipment configured to ease movement of one or more of the individual elements.

13. The method of claim 10, wherein the identification tags are electronic and configured to be printed and physically attached to corresponding individual elements.

14. The method of claim 13, wherein a printed unique identification code is configured to be scanned by a computing device associated with the user and/or the moving services provider to automatically identify a corresponding individual element responsive to the scan.

15. The method of claim 10, further comprising determining whether one or more items on the list of required actions was not completed, and generating a warning responsive to one or more of the items on the list of required actions not being completed.

16. The method of claim 10, wherein the list of required actions is synced from a pre-move inventory that was completed by a user, the moving services provider, and/or a third party.

17. The method of claim 10, wherein the one or more hardware processors are further configured to:
determine a non-moving element from items identified from the images; and
add an annotation to the non-moving element utilizing a graphical user interface.

18. An interactive moving services system, the system comprising one or more hardware processors configured by machine readable instructions to:
receive, at an Al module, an image of an object acquired by an image capture device;
compare, by the Al module, at least a portion of the image corresponding to the object to images in a training library;
determine, by the Al module, based on the comparing, whether the portion of the image indicates that the object is damaged; and
generate an indication of the determined damage.

19. The system of claim 18, the one or more hardware processors are further configured to:
receive one or more bounding boxes surrounding the portion of the image, wherein the determining is further based on the portion of the image inside the one or more bounding boxes.

20. The system of claim 18, the one or more hardware processors are further configured to:
compare the portion of the image to images of known damage types present in the training library; and
determine a type of damage present with the object based on the comparing with the known damage types.
